(19) United States
(12) Patent Application Publication
(10) Pub. No.: US 2010/0107063 A1
(43) Pub. Date: Apr. 29, 2010

(54) Automated visual analysis of nearby markings of a visualization for relationship determination and exception identification

(76) Inventors: Ming C. Hao, Palo Alto, CA (US); Umeshwar Dayal, Saratoga, CA (US); Chantal Tremblay, Notre-Dame-De-La-Merci (CA); Ram Ranganathan, Palo Alto, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/290,281

(22) Filed: Oct. 28, 2008

(51) Int. Cl. G06F 7/06; G06F 17/30; G06F 3/048; G06F 17/00

(52) U.S. Cl. 715/273; 715/764; 707/E17.014

(57) ABSTRACT

To automatically visually analyze relationship in data records that are presented by a visualization containing cells representing corresponding data records, identification of a threshold of interest is received for a particular one of attributes in the visualization. Nearby areas in the visualization are marked based on the threshold, and data records in the marked areas are mined to determine at least one relationship between the particular attribute and at least one other attribute, and to identify information associated with an exception. A result of the mined at least one relationship is provided, for display, in a graphical element.

### BACKGROUND

Often, it may be desirable to detect patterns or trends in data relating to execution of a system. For example, a system administrator may wish to visualize patterns or trends in measured performance data relating to the workload or system performance in a multiprocessor system. The system administrator may wish to understand if any workload is running for too long a period of time, or if some system resource (e.g., processor resource or storage resource) is being used excessively, which can cause delays or bottlenecks in the system.

Traditional tools generally lack the ability to provide meaningful or convenient views of performance data relating to a system in real time. User interfaces provided by such traditional tools may present limited information on a particular data item (e.g. threshold) and generally lack nearby information, and the features available to understand relationships among different types of performance data may not be available. As a result, such traditional tools have not enabled users to efficiently troubleshoot issues that may be present in systems.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments of the invention are described, by way of example, with respect to the following figures:

FIG. 1 illustrates a real time visualization screen containing cells representing respective time interval data records, in accordance with an embodiment;

FIG. 2 is a flow diagram of an automated process of marking nearby areas in real time of a visualization screen, according to an embodiment;

FIG. 3 is a flow diagram of a process of identifying relationships among attributes in a marked nearby area, according to an embodiment;

FIG. 4 illustrates combining boundary overlapping marked nearby areas to produce a larger marked area for analyzing nearby information and relationships, according to an embodiment;

FIGS. 5 and 6 illustrate pop-up screens for presenting results of mined relationships among attributes of data records, in accordance with an embodiment; and

FIG. 7 is a block diagram of an example computer in which processing software according to an embodiment is executable.

### DETAILED DESCRIPTION

In accordance with some embodiments, a nearby markings analytics technique or mechanism for identifying an exception(s) is provided for analyzing, in real time (or substantially in real time) relationships among attributes of multiple time series data records that are presented by a visualization (which contains cells that represent corresponding data records). Each data record has multiple attributes. For example, the data records can be performance data measured by monitors regarding operation of components of a system (e.g., CPU busy %, queue length, disk usage, query execution time, and so forth).

A “visualization” refers to a displayable representation of data, which can be in the form of a graphical user interface (GUI) screen or other graphical element, for example. To guide a user in identifying exceptions (and underlying information associated with the exceptions) quickly, the nearby markings analytics technique is provided that is built on a user-defined threshold being exceeded (e.g., CPU Busy %>95%). The technique identifies areas (including data records) surrounding the data record that exceeded the threshold. The technique joins smaller adjacent nearby areas into larger nearby areas and uses an optimization method to minimize the overlap of the areas. The technique enables users to focus on the important data helping them to detect root causes of exceptions. Note that “exceeding a threshold” means that a value of the particular attribute may be above or below the threshold, or have some other predefined relationship with respect to the threshold. A “threshold” refers to a single value, a group of values, a function, or other information or object to which a comparison can be made. Note also that multiple thresholds can be defined for multiple attributes.

An area having some predefined size surrounding at least one cell associated with a data record having the particular attribute that exceeds the threshold is marked. Marking such an area surrounding the cell is also referred to as identifying a nearby area that includes cells corresponding to nearby time interval records. The process of marking a nearby area uses an automated nearby marking process that identifies cells that are associated with a particular attribute that exceeds a threshold. The automated nearby marking process also iteratively joins small adjacent nearby areas into larger nearby areas without boundary overlap and without distinct areas in the same column of the visualization. In some implementations, the automated nearby marking process optimizes the joining of the small adjacent nearby areas to reduce or minimize overlap of nearby areas. By using the marking process according to some embodiments, users are allowed to focus on the more important or interesting data to help users detect problems or issues, such as problems associated with a query that has been submitted to obtain the data presented in the visualization.

Data records in the marked area can then be mined to determine at least one relationship between the particular attribute and at least one other attribute of the data records in the marked area. A result of the mined relationship can be presented for display. In this way, a user is allowed to view a bigger picture of the data presented in the visualization, rather than just small pieces of detailed data.

In some embodiments, mining data records in the marked area to determine the at least one relationship between the particular attribute and at least one other attribute involves studying the values of the various attributes associated with the data records in the marked area, and detecting whether there are any correlations between the particular attribute and the other attributes. A correlation between the particular attribute and a second attribute may exist if any one or more of the following is true: (1) over time, as values of the particular attribute vary between high and low values, the values of the second attribute follow substantially the same trend as the values of the particular attribute; or (2) over time, as values of the particular attribute vary between low and high values, the values of the second attribute have a trend that is opposite the trend of the values of the particular attribute (this is considered an inverse correlation relationship).

With the nearby markings analytics technique provided by some embodiments, a user is presented with a convenient tool for identifying exceptions (e.g., anomalies, outliers, problems, etc.) in a visualization of data records. Also, the user is allowed to drill down into areas of the visualization associated with anomalies so that relationships among attributes that may have led to the exceptions can be identified. The causes and impacts of the nearby areas can be determined. In addition, a user can determine whether the exceptions (attribute values exceeding a threshold or multiple thresholds) occur occasionally or consistently. Also, a user can easily determine the initial and ending states (e.g., data values) associated with the particular attribute in the neighborhood of where the threshold is exceeded. Moreover, it can be determined which other attribute(s) most correlate(s) to an attribute that has exceeded a threshold. Such most correlated attribute(s) can then be further mined to obtain a more detailed understanding.

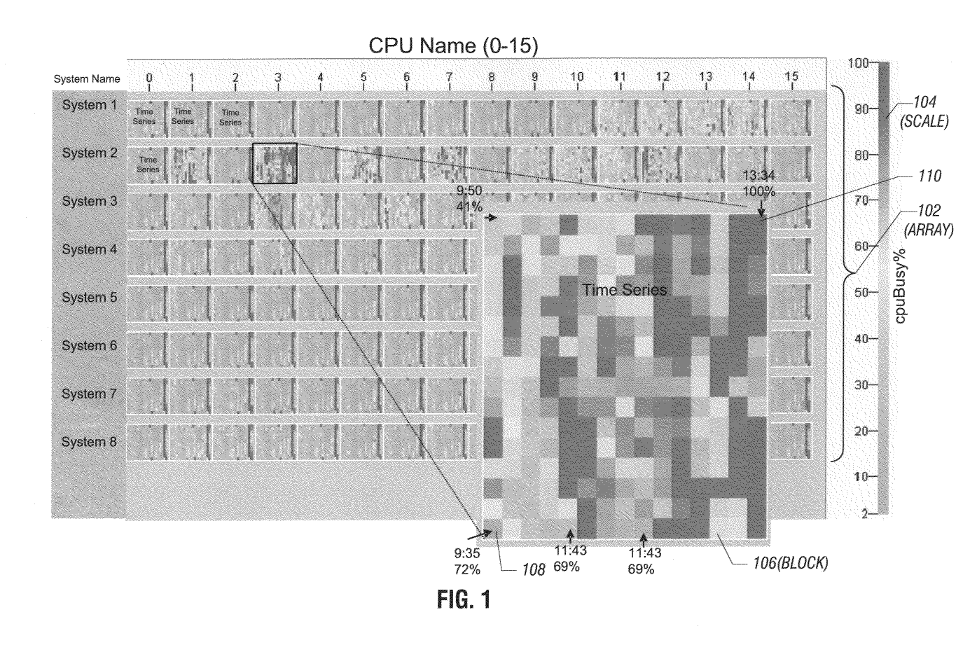

FIG. 1 illustrates a visualization screen 100 (which is displayable in a display device) for visualizing data records. The data records can relate to performance of components of a system. Example attributes of data records include CPU busy % (to indicate a percentage of time that a CPU is busy), queue length (length of a queue waiting for execution), queue execution time (length of time to execute a query), server busy % (percentage of time that a server is busy), and so forth. The data records can be retrieved from a database (e.g., data warehouse) or can be received in real time or substantially in real time.

The visualization screen 100 can be in the form of a GUI screen, which can be a window provided by various operating systems, including WINDOWS® operating systems, UNIX® operating systems, LINUX® operating systems, etc., or other type of image. The visualization screen 100 depicts a main array 102 of cells arranged as multiple rows (eight rows depicted) and multiple columns (sixteen columns depicted).

The columns in FIG. 1 correspond to sixteen CPUs (CPU 0 through CPU 15). The rows correspond to eight systems, where each system can include sixteen CPUs. For example, the multiple systems can refer to multiple CPUs, etc.

The intersection of each row and column corresponds to a block 106 (one block depicted in greater detail in FIG. 1), where the block 106 includes a sub-array of cells assigned to different colors (or other types of visual indicators) according to values of measurements, such as CPU busy % and so forth. Each cell represents a corresponding time interval data record. Each block 106 represents a time series of data records, starting at the lower left corner 108 and ending at the upper right corner 110 in one exemplary implementation. The color of each cell represents the value of a measured attribute (referred to as a “coloring attribute”), such as CPU busy % (to indicate the percentage of time that the CPU is busy executing instructions). The ordering of the cells in the block 106 is according to time, starting at the lower left corner and ending at the upper right corner. Each cell corresponds to some measurement interval (e.g., one minute). The time ordering of cells in each block 106 is as follows: start at lower left corner, proceed right, then up until reading the upper right corner of the block 106. In other implementations, ordering of cells in each block 106 can be based on other attributes besides time.

A scale 104 is provided on the right side of the visualization screen 100 to show mapping between values of the coloring attribute of the data records and corresponding colors. The cells are assigned colors according to the values of the coloring attribute in corresponding sub-intervals. In the example depicted in FIG. 1, the coloring attribute is the measured attribute, CPU busy %.

Although described in the context of the example visualization screen 100 of FIG. 1, other embodiments can be used with other color-based (or non-color-based) visualization screens that are capable of representing data records.

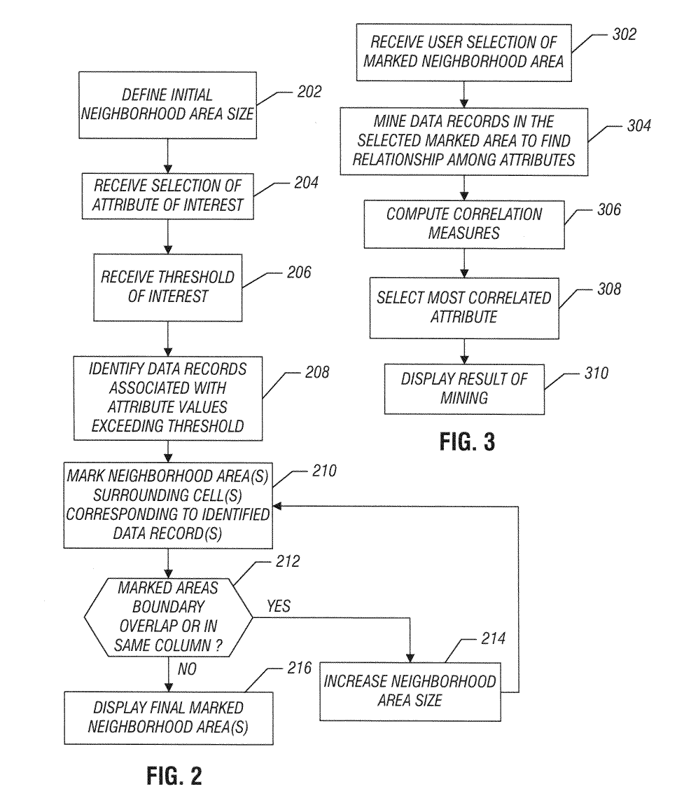

Reference is made to FIG. 2 in the ensuing discussion. An initial nearby area size is defined (at 202). The nearby area size refers to the size of the area (to be marked) surrounding a cell corresponding to a data record having an attribute that has exceeded a predefined threshold. The area can be rectangular, circular, oval, or of other shape. Next, the process receives (at 204) identification of an attribute of interest. This attribute of interest can be selected by a user, or it can be a predefined attribute. The process also receives (at 206) a threshold of interest. Again, the threshold of interest can be user-selectable, or the threshold of interest can be a predefined threshold.

Note that selections of multiple attributes of interest and multiple corresponding thresholds can be received (at 204, 206).

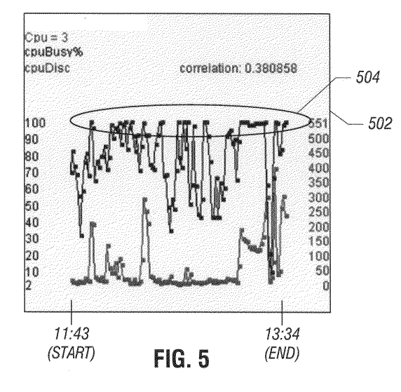

The process then analyzes the visualization screen, such as visualization screen 100 in FIG. 1, to identify (at 208) data records associated with attribute values that exceed the threshold. The area(s) surrounding the cell(s) corresponding to the identified data record(s) is (are) then marked (at 210). An example of marked areas is depicted in a visualization screen portion depicted in FIG. 4, where the marked areas include marked areas m1-m22, for example.

Next, the process of FIG. 2 determines (at 212) whether any of the marked areas boundary overlap or whether two or more marked areas reside in the same column of the visualization. Overlapping marked areas refer to marked areas where the corresponding boundaries of the areas intersect. If there are any marked areas that overlap or if there are distinct marked areas residing in the same column of the visualization, then the nearby area size is increased (at 214), such as by an incremental size.

The process then returns to task 210 to mark nearby area(s) surrounding cell(s) associated with data records having attributes values exceeding the predefined threshold. The marked nearby areas have a size equal to the increased nearby area size indicated at 214. The marking of a nearby area with increased size effectively combines previously overlapping nearby areas or distinct nearby areas residing in the same column. In an alternative embodiment, instead of combining distinct marked areas residing in the same column, distinct marked areas in a row or other visualization portion can be combined. The incremental increase of nearby area sizes (214) and subsequent marking of larger nearby areas with the increased sizes (210) are performed iteratively until no marked areas overlap (in other words, there is no overlap of boundaries of the marked areas) and no distinct marked areas reside in the same column. Such marked areas are iteratively combined into increasingly larger marked areas until no further marked areas overlap and no distinct marked areas reside in the same column. Boundaries of two marked areas overlap if such boundaries either cross (intersect) or touch each other.

FIG. 4 shows an example of combining overlapping marked nearby areas (and distinct marked nearby areas residing in the same column) into a larger marked nearby area. In FIG. 4, initially there are a number of overlapping marked areas and marked areas residing in the same column (m1, m2, . . . , m22). After iteratively increasing the predefined nearby area size, the overlapping marked areas and marked areas in the same column are combined into larger marked areas, represented as n1, n2, n3, and n4 in FIG. 4. Note that the nearby areas n1, n2, n3, and n4 do not have overlapping boundaries and do not reside in the same column. Note that times and CPU Busy % values are displayed for some of the marked areas n1-n4. For example the starting time for nearby area n4 is 11:43, and the ending time is 13:34, as indicated in FIG. 4.

In the example of FIG. 4, nearby areas m1 and m2 are not combined with other nearby areas. Thus, areas n1 and n2 are the same as m1 and m2, respectively. However, nearby areas m3-m7 are combined into a larger nearby area n3. Similarly, nearby areas m8 to m22 are combined into n4. The nearby area combining process depicted in the example of FIG. 4 allows for a user to more quickly find problems associated with attributes exceeding thresholds.

Once there are no further overlapping marked areas, then the final marked nearby area(s) is (are) displayed (at 216) with predefined boundaries, such as black rectangles.

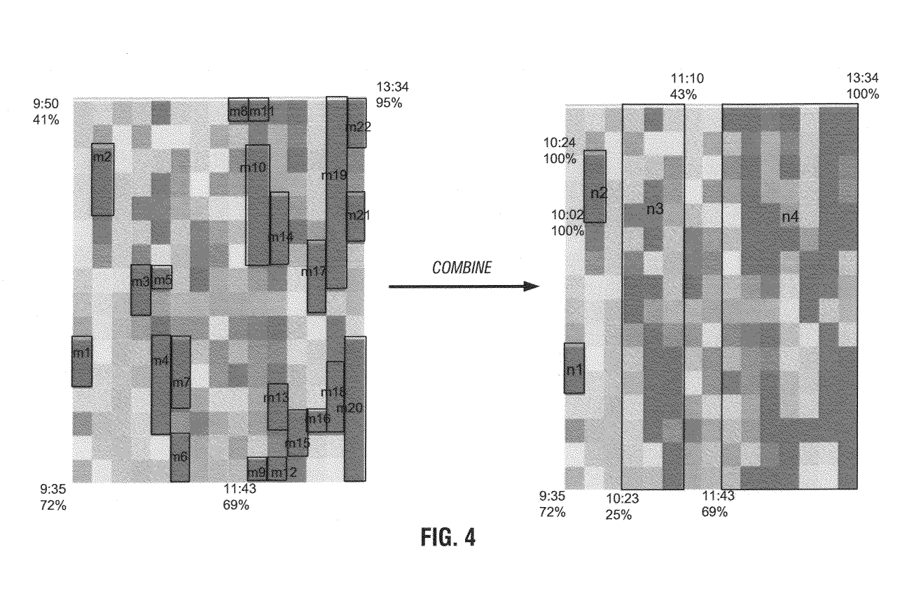

The marked nearby boundaries allow a user to easily detect anomalies that are present in the visualization screen. A user may select one of the marked nearby areas for further analysis. The user can do so by moving a pointer (e.g., mouse pointer) over the desired marked nearby area. Other mechanisms for performing selections can be performed in other implementations. As depicted in the flow diagram of FIG. 3, a user selection of a marked nearby area is received (at 302). In response to selection of a marked nearby area, the process mines (at 304) the data records in the marked nearby area to find relationships among the attributes of the data records in the marked nearby area, such as relationships between the particular attribute that exceeded the threshold and one or more other attributes. Measures regarding correlations between the attributes are computed (at 306). Then the most correlated attribute (to the particular attribute that exceeded a threshold) is selected (at 308).

A result of the mining (e.g., graph or line chart depicting relationship between the particular attribute and the most correlated attribute) is then displayed (at 510) in a graphical representation, for example.

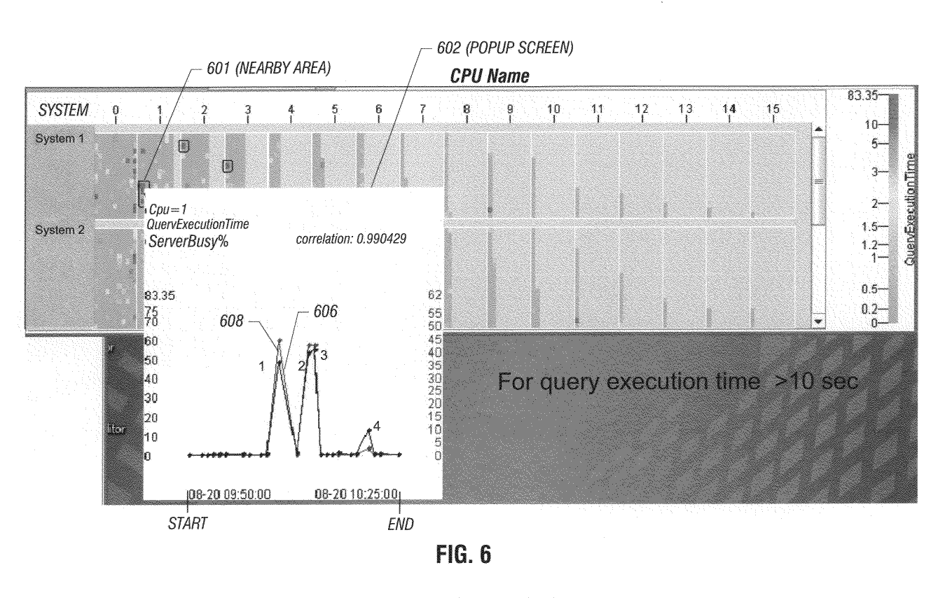

The result of the mining displayed at 310 can be displayed in a pop-up or tooltip screen, such as 502 in FIG. 5 or 602 in FIG. 6. In FIG. 5, the user had moved a mouse pointer over the combined marked area n4 (FIG. 4) to identify the correlation between CPU busy % and CPU disc usage. The correlation is relatively low. Moreover, according to FIG. 5, the CPU busy % values are persistently high (indicated in oval 504), which indicates that immediate action may have to be performed to address the high CPU busy usage. FIG. 5 also shows the starting time (11:43) and ending time (13:34) of nearby area n4 of FIG. 4.

The pop-up screen 602 of FIG. 6 contains the results for mining of data records in a nearby area 601. In the example of FIG. 6, the particular attribute that has exceeded a threshold in the marked nearby areas is a Query Execution Time attribute, which represents the execution time of a query. For example, the query and execution time threshold may be 10 seconds. In the pop-up screen 602, the query execution times for four queries (queries 1-4) are presented as a black line chart 606. Also, a highly correlated attribute, in this example Server Busy %, is also presented in the pop-up screen 602 as a blue line chart 608. Note that the Server Busy % attribute has values that generally follow the trend of the values of the Query Execution Time attribute (which indicates high correlation). In FIG. 6, unlike in FIG. 5, the CPU busy % is not persistently high (and is only occasionally high), which means that immediate action does not have to be performed.

In other examples, other pop-up screens (or other graphical elements) can present other details associated with the mined data records.

The tasks of FIGS. 2 and 3 discussed above may be provided in the context of information technology (IT) services offered by one organization to another organization. The IT services may be offered as part of an IT services contract, for example.

The automated nearby markings visual analytics technique or mechanism described above allows a user to more easily analyze complex information (or a large volume of information) to better understand the information such that operations associated with a system that is being analyzed can be improved. The nearby markings analytics technique transforms raw data having predefined one or more thresholds into valuable information to better understand the information. Valuable insight can be provided into core business operations and relationships associated with different attributes, such as using the tool tips 502 and 602 depicted in FIGS. 5 and 6. A user can quickly determine whether an exception (such as high CPU %) is occurring persistently or occasionally.

For example, in a database system, customers may perform large numbers of queries daily to access enterprise data from a database, such as a data warehouse. The queries often are complex with highly varying execution times. Some of the queries can run for unexpectedly long execution times and can consume large amounts of database system resources. Using the nearby markings analytics technique according to some embodiments, problem queries can be identified at run time of such queries, and possible causes of such problem queries can be determined.

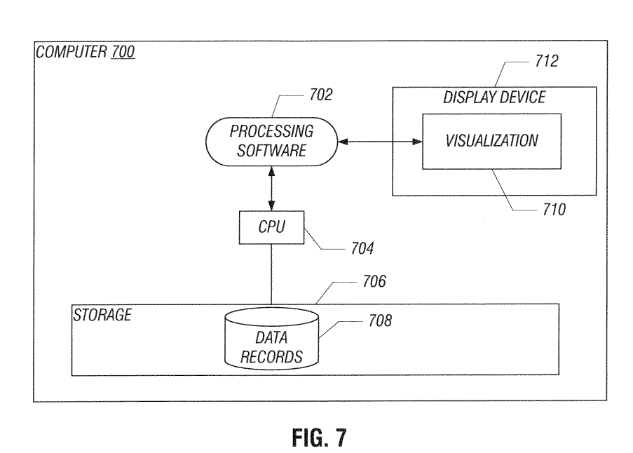

The tasks described above can be performed by processing software 702 that is executable in a computer 700, as depicted in FIG. 7. The processing software 702 is executable on one or more central processing units (CPUs) 704, which is (are) connected to a storage 706. Data records 708 that are to be analyzed can be stored in the storage 706.

Based on processing performed by the processing software 702, a visualization 710 can be presented in a display device 712 of the computer 700 by the processing software 702. Moreover, user selections made in the visualization 710 can be received by the processing software 702.

Instructions of the processing software 702 are loaded for execution on a processor (such as one or more CPUs 704). The processor includes microprocessors, microcontrollers, processor modules or subsystems (including one or more microprocessors or microcontrollers), or other control or computing devices. A “processor” can refer to a single component or to plural components.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method to automatically visually analyze, in real-time, a relationship in data records that are presented by a visualization containing cells representing corresponding data records, comprising:
receiving identification of a threshold of interest for a particular one of attributes in the data records;
automatically marking nearby areas in the visualization based on the threshold;
mining data records in the marked areas to determine at least one relationship between the particular attribute and at least one other attribute, and to identify information associated with an exception; and
providing, for display in a graphical element, a result of the mined at least one relationship.

2. The method of claim 1, wherein automatically marking the nearby areas in the visualization comprises joining smaller nearby areas into the marked nearby areas to prevent overlap of boundaries of the smaller nearby areas.

3. The method of claim 1, wherein automatically marking the nearby areas in the visualization comprises automatically marking the nearby areas in the visualization that include corresponding data records each having the particular attribute exceeding the threshold.

4. The method of claim 3, further comprising:
determining whether at least two of the marked nearby areas overlap; and
in response to detecting the overlap, combining the at least two marked nearby areas into a larger marked area.

5. The method of claim 4, further comprising:
setting an initial size for each of the nearby areas; and
in response to detecting the overlap, increasing the size to enable creation of the larger marked area.

6. The method of claim 4, further comprising:
iteratively combining the marked nearby areas until no further overlap of marked nearby areas is present in the visualization.

7. The method of claim 3, further comprising:
determining whether at least two of the plural marked nearby areas occur in a column of the visualization; and
in response to determining that the at least two marked nearby areas occur in the column, combining the at least two marked nearby areas into a larger marked area.

8. The method of claim 1, further comprising displaying the result of the mined at least one relationship in an interactive graphical element to enable user drill down to additional detail regarding the data records in the marked nearby areas.

9. The method of claim 1, wherein the marked nearby area include corresponding data records each having the particular attribute exceeding the threshold, the method further comprising:
detecting a pointer in the visualization being moved over a particular one of the marked nearby areas; and
in response to detecting the pointer moved over the particular marked nearby area, displaying additional detail regarding the data records in the particular marked nearby area.

10. The method of claim 1, wherein providing, for display, the result of the mined at least one relationship in the graphical element comprises providing a first representation of the particular attribute and a second representation of the at least one other attribute in the graphical element.

11. The method of claim 10, wherein the first representation comprises a first chart, and the second representation comprises a second chart.

12. The method of claim 1, further comprising:
based on data records contained in the marked nearby areas, producing second marked areas corresponding to data records having a second attribute exceeding a second threshold.

13. The method of claim 12, further comprising:
receiving user selection of one of the second marked areas, and
presenting correlations among attributes for the data records in the selected one of the second marked areas.

14. The method of claim 1, further comprising providing information technology services, wherein the receiving, marking, mining, and providing tasks are part of the information technology services.

15. A method of analyzing data records, comprising:
receiving selection of an attribute of interest, the attribute of interest contained in the data records;
receiving a threshold of interest;
automatically marking nearby areas in a visualization of the data records, wherein the marked nearby areas contain data records having the attribute exceeding the threshold;
mining data records in at least one of the marked nearby areas; and
providing, for display, a detail related to mining of the data records in the at least one marked nearby area.

16. The method of claim 15, further comprising:
determining whether at least two of the plural marked nearby areas overlap; and
in response to detecting the overlap, combining the at least two marked nearby areas into a larger marked area.

17. The method of claim 16, further comprising:
iteratively combining the marked nearby areas until no further overlap of marked areas is present in the visualization.

18. The method of claim 15, wherein providing, for display, the detail related to mining of the data records in the at least one marked nearby area comprises:
representing a correlation between the attribute of interest and at least another attribute.

19. An article comprising at least one computer-readable storage medium containing instructions that when executed cause a computer to:
receive identification of a threshold of interest for a particular one of the attributes;
automatically mark areas in a visualization based on the threshold;
combine the marked areas if boundaries of the marked areas overlap or if the marked areas occur in a particular portion of the visualization.

20. The article of claim 19, wherein combining the marked areas if the marked areas occur in the particular portion of the visualization comprises combining the marked areas if the marked areas occur in a column of the visualization.
